(19) United States
(12) Patent Application Publication
(10) Pub. No.: US 2023/0103013 A1
(43) Pub. Date: Mar. 30, 2023

(54) METHOD FOR PROCESSING IMAGE, METHOD FOR TRAINING FACE RECOGNITION MODEL, APPARATUS AND DEVICE

(71) Applicant: BEIJING BAIDU NETCOM SCIENCE TECHNOLOGY CO., LTD., Beijing (CN)

(72) Inventor: Jianwei LI, Beijing (CN)

(21) Appl. No.: 17/936,109

(22) Filed: Sep. 28, 2022

(30) Foreign Application Priority Data
Sep. 29, 2021 (CN) 202111157086.5

(51) Int. Cl. G06V 40/16; G06V 10/77; G06V 10/26

(52) U.S. Cl. CPC G06V 40/172; G06V 10/7715; G06V 10/267

(57) ABSTRACT

A method for processing an image includes: obtaining a face image to be processed, and dividing the face image to be processed into image patches; determining respective importance information of the image patches of the face image to be processed; obtaining a pruning rate of a preset vision transformer (ViT) model; inputting the image patches into the ViT model, and pruning inputs of network layers of the ViT model according to the pruning rate and the respective importance information of the image patches, to obtain a result outputted by the ViT model; and determining feature vectors of the face image to be processed according to the result outputted by the ViT model.

### CROSS REFERENCE TO RELATED APPLICATIONS

This application claims priority to and benefits of Chinese Application No. 202111157086.5, filed on Sep. 29, 2021, the entire disclosure of which is incorporated herein by reference.

### TECHNICAL FIELD

The disclosure relates to a field of artificial intelligence (AI) technologies, in particular to the fields of computer vision and deep learning technologies, and can be applied to scenes such as image processing and image recognition, in particular to a method for processing an image, a method for training a face recognition model, related apparatuses and devices.

### BACKGROUND

Recently, Vision Transformer (ViT) model has been greatly developed, and the Transformer model has achieved excellent results in competitions in various visual field. Compared with the convolutional neural network model, the Transformer model generally requires huge computing power for inference and deployment.

### SUMMARY

According to a first aspect, a method for processing an image is provided. The method includes:

obtaining a face image to be processed, and dividing the face image to be processed into image patches;

determining respective importance information of the image patches;

obtaining a pruning rate of a preset vision transformer (ViT) model;

inputting the image patches into the ViT model, and pruning inputs of network layers of the ViT model based on the pruning rate and the respective importance information of the image patches to obtain a result outputted by the ViT model; and

determining feature vectors of the face image to be processed based on the result outputted by the ViT.

According to a second aspect, a method for training a face recognition model is provided. The method includes:

obtaining face image samples, and dividing each sample face image into image patch samples;

determining respective importance information of the image patch samples of the face image samples;

obtaining a pruning rate of a vision transformer (ViT) model;

for each face image sample, inputting the image patch samples into the ViT, and pruning inputs of network layers of the ViT model based on the pruning rate and the respective importance information of the image patch samples, to obtain a result outputted by the ViT model;

for each face image sample, determining feature vectors of the face image sample based on the result outputted by the ViT model, and obtaining a face recognition result based on the feature vectors; and

training the face recognition model according to the face recognition result of each face image sample.

According to a third aspect, an electronic device is provided. The electronic device includes: at least one processor and a memory communicatively coupled to the at least one processor. The memory stores instructions executable by the at least one processor, and when the instructions are executed by the at least one processor, the method according to the first aspect of the disclosure, and/or, the method according to the second aspect of the disclosure is implemented.

According to a fourth aspect, a non-transitory computer-readable storage medium having computer instructions stored thereon is provided. The computer instructions are configured to cause a computer to implement the method according to the first aspect of the disclosure, and/or, the method according to the second aspect of the disclosure.

According to a fifth aspect, a computer program product including computer programs is provided. When the computer programs are executed by a processor, the method according to the first aspect of the disclosure, and/or, the method according to the second aspect of the disclosure is implemented.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure.

FIG. 1 is a schematic diagram illustrating a vision transformer (ViT) model according to some examples of the disclosure.

FIG. 2 is a flowchart illustrating a method for processing an image according to some examples of the disclosure.

FIG. 3 is a flowchart illustrating a pruning process for the input of each network layer according to some examples of the disclosure.

FIG. 4 is a flowchart illustrating another pruning process for the input of each network layer according to some examples of the disclosure.

FIG. 5 is a flowchart illustrating yet another pruning process for the input of each network layer according to some examples of the disclosure.

FIG. 6 is a schematic diagram illustrating a pruning process for inputs of network layers according to some examples of the disclosure.

FIG. 7 is flowchart illustrating a method for training a face recognition model according to some examples of the disclosure.

FIG. 8 is a schematic diagram illustrating an apparatus for processing an image according to some examples of the disclosure.

FIG. 9 is a schematic diagram illustrating another apparatus for processing an image according to some examples of the disclosure.

FIG. 10 is a block diagram illustrating an electronic device configured to implement embodiments of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

In the technical solution of the disclosure, the acquisition, storage and application of the involved user personal information all comply with the provisions of relevant laws and regulations, and do not violate public order and good customs. The user' personal information involved is obtained, stored and applied with the user' consent.

It is noteworthy that, in some embodiments of the disclosure, the visual transformation model refers to the ViT model. Recently, the ViT model has been greatly developed, and the Transformer model has achieved excellent results in competitions in various visual field. However, compared with the convolutional neural network model, the Transformer model generally requires huge computing power for inference and deployment, which makes it urgent to miniaturize and compress the Transformer model.

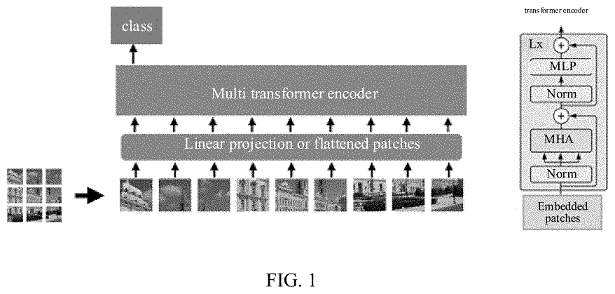

The structure of the ViT model is illustrated in FIG. 1. In the Transformer model, an image is divided into a plurality of image patches. An image patch corresponds to one input position of the network. Multi transformer encoder stacks a multi-layer Transformer Encoder module. There are two norm modules in this module, i.e., a Multi Head Attention (MHA) module and a Multilayer Perceptron (MLP) module.

Currently, in the related pruning technology, the pruning process is performed to mainly reduce the number of layers and the number of heads of the ViT model. These pruning schemes are only focused on some of the dimensions during the calculation process. In the calculation process, the number of image patches also affects the computing amount of the ViT model.

However, the pruning performed in the dimension of the number of image patches has great limitations in ordinary classification tasks. For example, objects of interest may appear in any position of the image, and thus pruning the image patches may require a special aggregation operation to converge layer-to-layer information transfer. Such an operation increases the computing amount, but it does not necessarily make the information integrated and converged.

For a face recognition model, before an image is input into the ViT model, the image will be detected and aligned to achieve the highest accuracy. After these operations, each face image will have roughly the same structure, such that respective importance of patches of each face image have roughly the same ordering. Therefore, the image patches can be pruned according to the respective importance of the image patches, to reduce the calculation for less important image patches, and to reduce the computing power consumption of the ViT model.

In view of the above problems and findings, the disclosure provides a method for processing an image, which can reduce the computing consumption in the image processing process by pruning inputs of network layers of the ViT model.

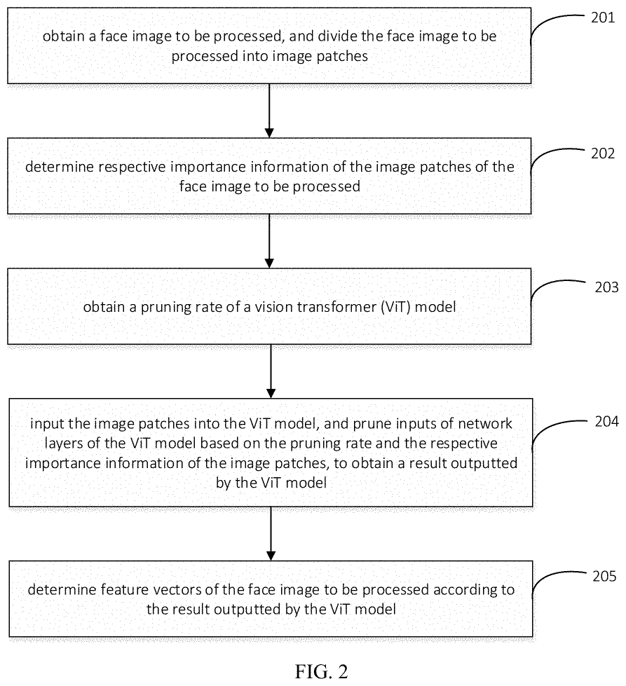

FIG. 2 is a flowchart illustrating a method for processing an image according to some examples of the disclosure. The method is mainly used for processing face images and the face recognition model in the processing process has been trained. The face recognition model includes a ViT model, which means that the ViT has also been trained. It is noteworthy that the method according to examples of the disclosure may be executed by an apparatus for processing an image according to some examples of the disclosure, and the apparatus may be included in an electronic device, or may be an electronic device. As illustrated in FIG. 2, the method may include the following steps.

In step 201, a face image to be processed is obtained and divided into a plurality of image patches.

It is understandable that, in order to enable the model to fully extract features of the face image to be processed, the face image to be processed can be divided into the plurality of image patches. Sizes of the plurality of image patches are the same, and the number of image patches equals to the number of inputted image patches to be inputted into the preset ViT model.

In step 202, respective importance information of the plurality of image patches of the face image to be processed is determined.

It is understandable that, not all image patches of the face image to be processed contain important features of the face, and some image patches may only be the background of the face image, which does not play a great role in the extraction of face features. Therefore, if the ViT model extracts features through learning from all image patches of the face image to be processed, a certain amount of computing power will be wasted on some less important image patches.

At the same time, for the face recognition model, before an image is inputted into the ViT model, the image will be detected and aligned. After these operations, each face image will have roughly the same structure, that is, the distribution of respective importance of the patches of each face image may be roughly the same. Therefore, the respective importance information of the image patches can be determined through the statistics of a large amount of face images.

For example, face images can be acquired in advance. The acquired face images refers to the images that includes faces and have been aligned. Each face image is divided into image patches. The number of image patches obtained through the division is the same for all face images. The trained face feature extraction model is configured to determine respective feature information contained in the image patches. The feature information of image patches having the same location index included in all face images are considered comprehensively, and if the image patches having the location index, such as the location index is 1, included in the face images all contain a large amount of face feature information while the image patches having the location index, such as the location index is 3, almost do not contain face feature information, it can be determined that the importance of the image patches having the location index, i.e. 1, is greater than that of the image patches having the location index, i.e. 3. For example, the location index can be the coordinate of a center point of the image patch or each image patch is numbered as 1, 2, . . . q, where q is an integer greater than 1 and thus the location index is the number. In this way, the respective importance information of the image patches having different location indexes can be obtained. The determined importance information can be applied to all face images having the same structure. Therefore, the respective importance information of the image patches included in the face image to be processed can be determined.

As an implementation, in the calculation process of the Transformer Encoder layer of the ViT model, the attention matrix reflects respective importance of image patches relative to other image patches. In the attention matrix, each element indicates an importance of an image patch having the same location index as the element and the number of elements of the attention matrix is the same as the number of image patches of the face image. Therefore, for the face image to be processed, the respective importance information of the image patches can be determined based on the attention matrixes outputted by the network layers of a trained ViT model. The determining method includes inputting the face image to be processed into a trained ViT model and obtaining the respective importance information of the image patches outputted by the trained ViT model. The training process of the ViT model includes the following. Face image samples are inputted into the ViT model to obtain respective attention matrixes corresponding to the face image samples outputted by each network layer. Each face image sample can be divided into image patch samples having different location indexes. Image patch samples at the same position in different face image samples can have the same location index. In each network layer, for groups of image patch samples having the same location index in different face image samples, respective weights of the groups of image patch samples are determined by fusing the attention matrixes of different face image samples. The respective importance information of the groups of image patch samples is determined based on the respective weights of all network layers. The weight and importance information of each image patch included in a group equal to those determined for the group. As an example, there are two face images having the same structure as the face image to be processed, and thus two attention matrixes are outputted by each network layer of the ViT model, e.g., a first attention matrix and a second attention matrix. The first attention matrix corresponds to one face image and the second attention matrix corresponds to another face image. If each face image can be divided into 4 image patches, then the first and second attention matrixes each include 4 elements. Each element indicates the importance of an image patch having the same location index as the element. For the image patch having the location index of 1, the element having the location index of 1 of the first attention matrix and the element of the second attention matrix having the location index of 1 are fused to obtain a fusion result, and respective fusion results outputted by the network layers are fused as the weight of the image patch. Then, the importance information of the image patch is determined based on the weight. Therefore, after the face image to be processed having the same structure as the face image samples is inputted to the trained ViT model, the respective importance information of the image patches are determined. Since the values of each attention matrix are the softmax (maximum normalized activation function) results and each softmax result indicates an importance probability of one image patch, the weight of an image patch can be determined by fusing the importance probabilities of image patches having the same location index of the plurality of image samples. The fusing method can be adding the attention matrixes of all face images according to the matrix axis, or performing a weighted summation according to differences of the network layers in the actual application scenario, or other fusing methods can be adopted according to actual needs.

In step 203, a pruning rate of a preset ViT model is obtained.

The pruning rate of the ViT model refers to a ratio of the computing amount expected to be reduced in the computing process of multi-layer network, which can be obtained based on an input on an interactive interface, or through interface transfer parameters, or according to a preset value in the actual application scenario, or obtained in other ways according to the actual application scenario, which is not limited in the disclosure.

In step 204, the plurality of image patches are input into the ViT model, and inputs of network layers of the ViT model are pruned based on the pruning rate and the respective importance information of the image patches, to obtain a result outputted by the ViT model.

It is noteworthy that the result outputted by the ViT model is a node output in the face recognition model, and the result outputted is determined as input information of subsequent nodes of the face recognition model.

That is, the plurality of image patches of the face image to be processed are input into the ViT model, and the inputs of the network layers are pruned based on the pruning rate and the importance information of each image patch of the face image to be processed, which can reduce the computing amount of each network layer without affecting the feature extraction of the ViT model.

For example, a pruning number value (such as the pruning number value equals to N) can be determined for each network layer based on the pruning rate, and the number of image patches to be pruned from the inputs of each network layer equal to the pruning number value N. Image patches having low importance are selected layer by layer as the image patches to be pruned based on the respective importance information of the image patches. In this way, the feature information of the image patches to be pruned in the input of each network layer can be pruned, to obtain the result outputted by the ViT model.

As another example, the plurality of image patches of the face image to be processed can be sorted or ranked based on the respective importance information of the image patches, such as in a descending order of the importance information. Based on the pruning number value M determined for a network layer, features of M image patches at the tail of the sorted result are pruned from the input of the network layer, so as to realize the pruning of less important image patches without affecting the feature extraction of the face image to be processed by the ViT model.

It is noteworthy that the above-mentioned “network layer” in the ViT model refers to the Transformer Encoder layer in the ViT model.

In step 205, feature vectors of the face image to be processed are determined based on the result outputted by the ViT model.

When the plurality of image patches of the face image to be processed are input to the ViT model, the ViT model can supplement a virtual image patch. The result obtained after the virtual image patch passes through the Transformer Encoder layer is determined as the expression of the overall information of the face image to be processed, such that in the result outputted by the ViT, the corresponding feature vectors in the virtual image patch can be used as the feature vectors of the face image to be processed. In addition, some ViT models do not supplement a virtual image patch to learn the overall information of the face image to be processed. In this case, the result outputted by the ViT model can be directly used as the feature vectors of the face image to be processed.

With the method for processing an image according to some examples of the disclosure, the plurality of image patches of the face image to be processed are input to the ViT model, and the inputs of the network layers in the ViT model are pruned based on the pruning rate of the model and the respective important information of the image patches. Therefore, by reducing the input features of each network layer in the ViT model, the efficiency of image processing can be improved without affecting the feature extraction of the face image.

Based on the above examples, another pruning processing method of the inputs of the network layers in the ViT model is provided.

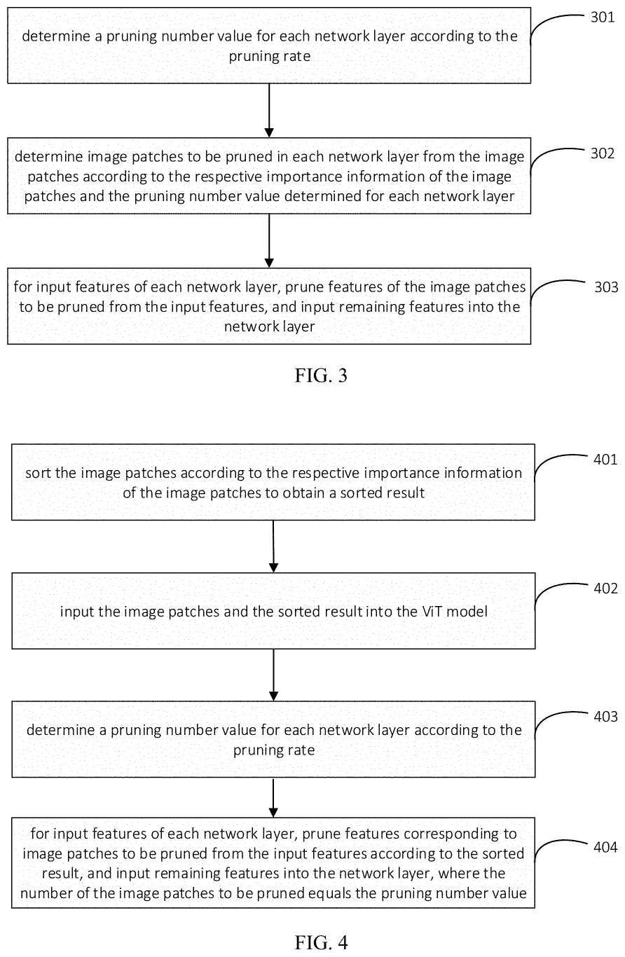

FIG. 3 is a flowchart illustrating a pruning process of inputs of each network layer according to some examples of the disclosure. As illustrated in FIG. 3, the pruning process includes the following steps.

In step 301, for each network layer, a pruning number value is determined for the network layer according to the pruning rate. The number of image patches to be pruned at each network layer equals to the pruning number value.

Since the ViT model contains multi-layer networks, in order to reduce the impact of pruning process on the feature extraction, the pruning processing can be carried out layer by layer. That is, the pruning processing is carried out gradually when the ViT model runs layer by layer, so as to avoid affecting the feature extraction of the current network layer and subsequent network layers caused by too much information pruned in the inputs of the current network layer.

A value of the number of image patches that need to be pruned in the network layer based on the pruning rate equals to the pruning number value determined for a network layer. The value of the number of image patches to be pruned in the network layer can be calculated based on the pruning rate. Respective pruning number values, that is the values of the number of image patches to be pruned, in the network layers can be the same or different, which can be determined according to the actual situation. For example, the total pruning number value of the image patches to be pruned in the ViT model can be calculated according to the number of image patches that are inputted into the ViT model and the pruning rate. If there are 120 image patches inputted to the ViT model (i.e., the number of image patches that are inputted into the ViT model is 120) and the ViT model includes a total of 10 network layers, when the pruning processing is not carried out, the inputs of each network layer include features of 120 image patches. If the pruning rate is 10%, the total pruning number value (i.e., the value of the number of the image patches to be pruned in the model) is 120 i.e., 120*10*10%=120. Therefore, it is determined that a sum of the value of the number of actually pruned image patches in all network layers is 120. If the pruning number value of the first layer is 2 and the pruning number value of the second layer is 2, the number of actually pruned image patches in the second layer is 4, and so on, until the sum of the values of the number of the actually pruned image patches in all network layers of the ViT model is 120, such that the pruning rate is reached. It is noteworthy that the value of the number of actually pruned image patches in each network layer can be the same or different, which can be set according to actual needs.

In step 302, for each network layer, image patches to be pruned are determined from the plurality of image patches for the network layer based on the respective importance information of the plurality of image patches and the pruning number value determined for the network layer.

It is understandable that the image patches to be pruned can be determined based on the respective importance information of the image patches. Therefore, based on the pruning number value determined for the network layer, the image patches to be pruned in the network layer can be determined.

As an instance, if the number of inputted image patches is 9, the pruning number value determined for each network layer is 1, and the importance information of the image patches ranked in the ascending order is as follows: the image patch having the location index of 3 (i.e., the image patch at the location numbered 3)<the image patch having the location index of 9<the image patch having the location index of 2<the image patch having the location index of 1<the image patch having the location index of 4<the image patch having the location index of 5<the image patch having the location index of 6<the image patch having the location index of 7<the image patch having the location index of 8, then it can be determined that the image patch to be pruned from the inputs of the first network layer is the image patch having the location index of 3, the image patch to be pruned from the inputs of the second network layer is the image patch having the location index of 9, the image patch to be pruned from the inputs of the third network layer is the image patch having the location index of 2, and so on. For ease of description, the form of “image patch +number” is used to represent an image patch having a corresponding location index, or an image patch at a corresponding position. For example, the image patch 3 represents an image patch having the location index of 3 or an image patch at a position numbered 3.

In step 303, for each network layer, features of the image patches to be pruned are pruned from input features of the network layer, and remaining features are input into the network layer.

In other words, the input features of each network layer are pruned, and then the remaining features are input to the corresponding network layer to reduce the computing amount of the ViT model by reducing the inputs of each network layer.

The input features of a network layer are equivalent to output features of a previous network layer. For example, the input features of the third network layer are equivalent to the output features of the second network layer. That is, before the input features of a network layer are input into the network, the input features are pruned, and the remaining features obtained after the pruning processing are inputted to the corresponding network layer.

As an example, for the third network layer mentioned in the above instance, the features corresponding to the image patch 2 are pruned from the input features of the third network layer, and the remaining features obtained after the pruning processing are inputted to the third network layer.

With the method for processing an image according to the disclosure, the pruning numbers are determined for the network layers respectively based on the pruning rate and for each network layer, the image patches to be pruned in the network layer are determined based on the respective importance information of the image patches and the pruning number value such that after the image patches to be pruned are pruned from the input features of the network layer, the features of the remaining image patches are inputted to the network layer. That is, the computing amount of each network layer can be reduced by reducing the information input of less important image patches in each network layer, to achieve the purpose of reducing the computational power of the ViT model without losing feature information. The less important image patches refer to the image patches that almost do not include face features.

Based on the above examples, another pruning processing method of the inputs of the network layers in the ViT model is provided.

FIG. 4 is a flowchart illustrating another pruning process of inputs of each network layer according to some examples of the disclosure. As illustrated in FIG. 4, the pruning process includes the following steps.

In step 401, the plurality of image patches are sorted based on the respective importance information of the plurality of image patches.

That is, the plurality of image patches are sorted according to the importance information of each image patch.

After the face image to be processed is divided into the plurality of image patches, the plurality of image patches are in a sequence based on the locations of the plurality of image patches in the face image to be processed. Dividing the face image to be processed into the plurality of image patches is equivalent to dividing the face image to be processed into different rows and columns of image patches. That is, the plurality of image patches are ranked in a location sequence, for example the image patches are ranked in the order of rows and columns, from top to bottom and from left to right.

Sorting the plurality of image patches based on the importance information is equivalent to disarranging the position sequence. The image patches having higher importance can be arranged at the head (that is the image patches are ranked in a descending order of the importance information), or the image patches having higher importance can be arranged at the tail (that is the image patches are ranked in an ascending order of the importance information). As an instance, there are a total of 120 image patches after the division and the image patches are arranged in the location sequence as {image patch 1, image patch 2, image patch 3, image patch 4, . . . , image patch 120}. It can be determined that the respective importance information of the image patches is as follows: image patch 3<image patch 10<image patch 11<image patch 34<image patch 1<image patch 2<image patch 115<image patch 13 . . . <image patch 44<image patch 45<image patch 47. Therefore, according to the respective importance information of the image patches, the sorted result obtained by sorting the image patches based on the importance can be: {image patch 47, image patch 45, image patch 44, . . . , image patch 13, image patch 115, image patch 2, image patch 1, image patch 34, image patch 11, image patch 10, image patch 3}.

In step 402, the plurality of image patches and the sorted result are input into the ViT model.

In step 403, for each network layer, a pruning number value is determined based on the pruning rate.

In step 404, for the input features of each network layer, after the features corresponding to the image patches to be pruned are pruned from the input features according to the sorted result, the features corresponding to remaining image patches are input into the network layer, where the number of the image patches to be pruned equals to the pruning number value.

That is, before inputting the input features into the network layer, the features corresponding to the image patches to be pruned can be pruned from the input features according to the sorted result, and then the remaining features can be input into the corresponding network layer. The number of the image patches to be pruned is the determined pruning number value.

For example, in the above instance, the plurality of image patches are sorted in the descending order according to the importance of the image patches, and the sorted result is {image patch 47, image patch 45, image patch 44, . . . , image patch 13, image patch 115, image patch 2, image patch 1, image patch 34, image patch 11, image patch 10, image patch 3}. If the pruning number value determined for the first network layer is 1 and the features before being inputted into the first network layer are the initial features of {image patch 47, image patch 45, image patch 44, . . . , image patch 13, image patch 115, image patch 2, image patch 1, image patch 34, image patch 11, image patch 10, image patch 3}, based on the sorted result, the features corresponding to the last image patch can be pruned, and the remaining features are the initial features of {image patch 47, image patch 45, image patch 44, . . . , image patch 13, image patch 115, image patch 2, image patch 1, image patch 34, image patch 11, image patch 10}, and the remaining features are input to the first network layer. If the pruning number value determined for the second network layer is 3 and the features before being inputted to the second network layer are the first features corresponding to {image patch 47, image patch 45, image patch 44, . . . , image patch 13, image patch 115, image patch 2, image patch 1, image patch 34, image patch 11, image patch 10}, in which the first features refers to the features outputted by the first network layer after learning and calculation, the remaining features after the pruning are the first features corresponding to {image patch 47, image patch 45, image patch 44, . . . , image patch 13, image patch 115, image patch 2, image patch 1} and the remaining features are inputted to the second network layer, and so on.

With the method for processing an image according to the disclosure, the plurality of image patches of the face image to be processed are sorted according to the respective importance information of the plurality of image patches, and after the features of a number of image patches are pruned from the input features of each network layer according to the sorted result, the remaining features are inputted to the corresponding network layer, such that the features of the first few image patches or the features of the last few image patches can be pruned directly based on the sorted result, which can further reduce the computing amount in the pruning process, improve the pruning efficiency, and further improve the efficiency of image processing.

In order to further avoid the influence of the pruning processing of the inputs of each network layer on the feature extraction of the face image, the method further includes the following.

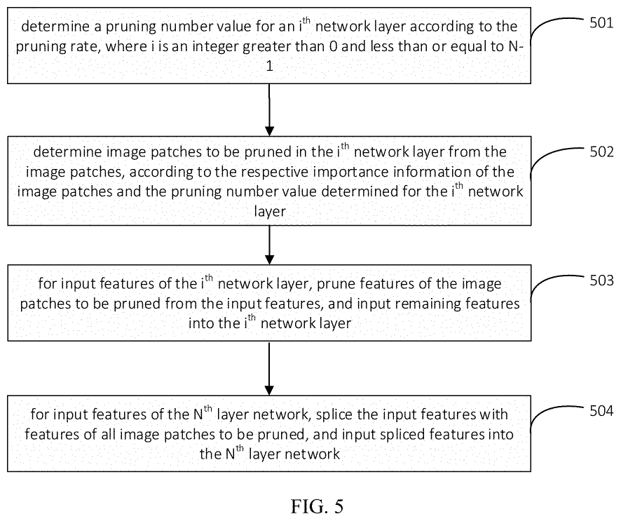

FIG. 5 is a flowchart illustrating yet another pruning process of inputs of each network layer according to some examples of the disclosure. For ease of description, the value N is used to represent the number of network layers in the ViT model, where N is an integer greater than 1. As illustrated in FIG. 5, the pruning process includes the following steps.

In step 501, a pruning number value is determined for an i^{th} network layer based on the pruning rate, where i is an integer greater than 0 and less than or equal to (N-1).

That is, respective pruning number values are determined for the first (N-1) network layers based on the pruning rate to perform the pruning processing, and the inputs of the N^{th} network layer are not pruned.

In step 502, image patches to be pruned in the i^{th} network layer are determined from the plurality of image patches, based on the respective importance information of the plurality of image patches and the pruning number value determined for the i^{th} network layer.

In step 503, for input features of the i^{th} network layer, features of the image patches to be pruned are pruned from the input features, and remaining features are inputted into the i^{th} network layer.

The pruning process method of the inputs of the first (N-1) network layers in step 502 and step 503 is consistent with the pruning process method of the inputs of the first (N-1) network layers in step 302 and step 303 in FIG. 3, which will not be repeated here.

In step 504, for input features of the N^{th} network layer, the input features are spliced or concatenated with the features of the all image patches to be pruned, and the spliced or concatenated features are input into the N^{th} network layer.

That is, the output features of the (N-1)^{th} network layer are spliced or concatenated with the features of all the image patches pruned from the input features in the first (N-1) network layers, and the spliced or concatenated features are inputted to the N^{th} network layer, which can not only reduce the computing power of the first (N-1) network layers, but also further reduce the impact of pruning processing on the face image feature extraction.

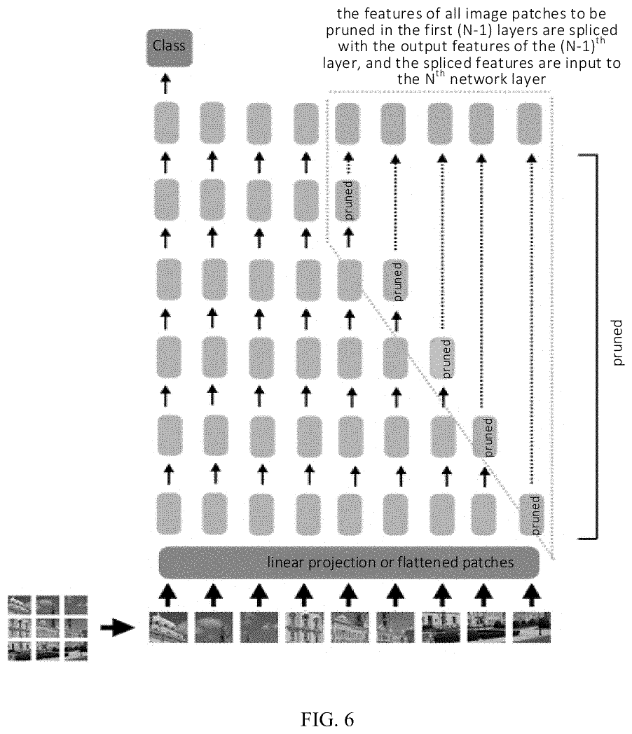

For ease of understanding, the implementation method of the embodiment of the disclosure can be as shown in FIG. 6. If the ViT model includes a total of 6 network layers, and in each of the first five network layers, the features of one image patch are pruned respectively from the inputs of the layer, then the inputs of the sixth network layer are the spliced or concatenated features obtained by splicing or concatenating the output features of the fifth network layer with the features corresponding to the pruned image patches from the first 5 network layers. That is, during the operation of the ViT model, the corresponding features of the pruned image patches in each pruning process need to be stored. When running to the last layer, the features of the pruned image patches can be called.

It is understandable that the inputs of the N^{th} network layer is equivalent to integrating all the features of the face image to be processed, so as to ensure that the features of the face image are not lost while reducing the computing amount.

With the method for processing an image according to the disclosure, for the ViT model including N network layers, the pruning processing is performed on the inputs of the first (N-1) network layers respectively, and the output features of the (N-1)^{th} layer network are spliced or concatenated with the features corresponding to the pruned image patches in the first (N-1) network layers and the spliced or concatenated features are inputted into the Nth network layer. On the one hand, the influence of the pruning processing on the feature extraction of face image can be further reduced, and on the other hand, the computing amount of the ViT model can also be reduced through the pruning processing of the first (N-1) network layers, so as to further improve the effect of pruning processing on image processing.

Embodiments of the disclosure also provide a method for training a face recognition model.

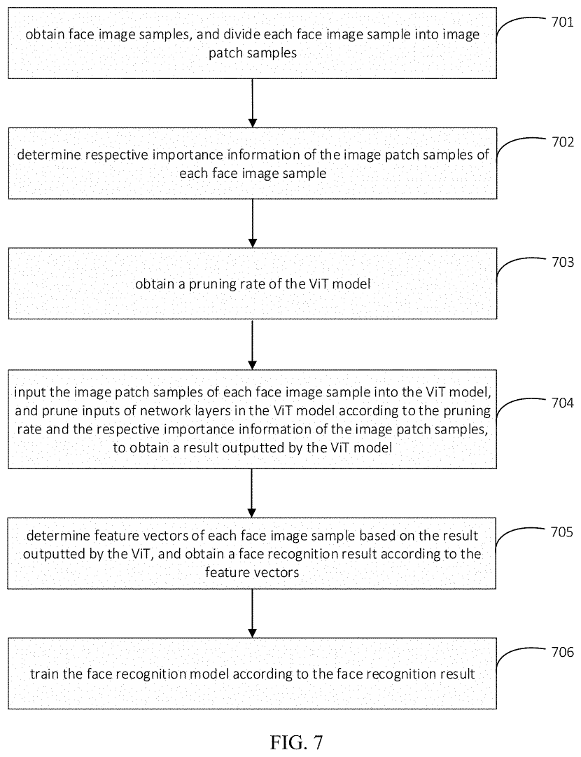

FIG. 7 illustrates a method for training a face recognition model according to some examples of the disclosure. The face recognition model includes a ViT model. It is noteworthy that the method for training a face recognition model can be executed by an apparatus for training a face recognition model according to some examples of the disclosure, and the apparatus can be included in an electronic device or may be an electronic device. As illustrated in FIG. 7, the method includes the following steps.

In step 701, face image samples are obtained and each face image sample is divided into a plurality of image patch samples.

It is understandable that, in order to enable the ViT model to fully extract the features of the face image sample, each face image sample can be divided into the plurality of image patch samples. Sizes of the plurality of image patch samples are the same, and the number of image patch samples equals to the number of inputted image patches to be inputted into the ViT model.

In step 702, respective importance information of the plurality of image patch samples of the face image samples are determined.

It is understandable that, not all image patch samples of the face image sample contain important features of the face, and some image patch samples may only be the background of the face image sample, which does not play a great role in the extraction of face features. Therefore, if the ViT model extracts features through learning from all image patch samples of the face image sample, a certain amount of computing power will be wasted on some less important image patches.

At the same time, before an image is inputted into the ViT model, the image will be detected and aligned. After these operations, each face image will have roughly the same structure, that is, the distribution of respective importance of the patches of each face image may be roughly the same. Therefore, the respective importance information of the image patch samples can be determined through the statistics of a large amount of face image samples.

Multiple face image samples can be obtained in advance. Each face image sample is divided into image patch samples. The number of image patch samples obtained through the division is the same for all face image samples. The face feature extraction model is configured to determine respective feature information contained in the image patch samples. Feature information of the image patch samples included in all face image samples are fused correspondingly, and if the image patch samples having the location index of 1 included in the face image samples all contain a large amount of face feature information while the image patch samples having the location index of 3 almost do not contain face feature information, it can be determined that the importance of the image patch samples having the location index of 1, is greater than that of the image patch samples having the location index of 3. In this way, the respective importance information of the image patch samples having different location indexes can be obtained. The determined importance information can be applied to all face image samples having the same structure. Therefore, the respective importance information of the image patches included in each face image sample can be determined.

As an implementation, in the calculation process of the Transformer Encoder layer of the ViT model, the attention matrix reflects respective importance of image patch samples relative to other image patch samples. Therefore, the respective importance information of the image patch samples can be determined based on the attention matrixes outputted by the network layers of the ViT model. The determining method includes the following. Face image samples are inputted into the ViT model to obtain respective attention matrixes corresponding to the face image samples outputted by each network layer. Respective weights of the image patch samples of each face image sample are determined by fusing all attention matrixes. The respective importance information of the image patch samples of each face image sample is determined based on the respective weights of the image patch samples of each face image sample. Since the values of each attention matrix are the softmax (maximum normalized activation function) results and each softmax result indicates an importance probability of one image patch sample, the weight of an image patch sample can be determined by fusing the importance probabilities of image patch samples having the same location index of the image samples. The fusing method can be adding the attention matrixes of all face image samples according to the matrix axis, or performing a weighted summation according to differences of the network layers in the actual application scenario, or other fusing methods can be adopted according to actual needs.

In step 703, a pruning rate of the ViT model is obtained.

The pruning rate of the ViT model refers to a ratio of the computing amount expected to be reduced in the computing process of multi-layer network, which can be obtained based on an input on an interactive interface, or through interface transfer parameters, or according to a preset value in the actual application scenario, or obtained in other ways according to the actual application scenario, which is not limited in the disclosure.

In step 704, for each face image sample, the plurality of image patch samples are input into the ViT model, and inputs of network layers of the ViT model are pruned based on the pruning rate and the respective importance information of the image patch samples, to obtain a result outputted by the ViT.

It is noteworthy that the result outputted by the ViT model is a node output in the face recognition model, and the result outputted is determined as input information of subsequent nodes of the face recognition model. The face recognition model is model trained with relevant training methods, that is, the above-mentioned “ViT model” is trained with relevant training methods.

In order to reduce the computing amount when the face recognition model is applied and ensure the accuracy of the model after pruning, the method for training a face recognition model according to the disclosure is equivalent to a fine-tuning process of the pruning processing performed on the inputs of each network layer.

As an implementation, pruning the inputs of the network layers in the ViT model includes: determining a pruning number value for each network layer based on the pruning rate; determining, from the plurality of image patch samples, image patch samples to be pruned from the inputs of each network layer according to the respective importance information of the image patch samples and the pruning number value determined for each network layer; and for input features of each network layer, pruning features of the image patch samples to be pruned from the input features, and inputting remaining features into the network layer.

As another implementation, pruning the inputs of the network layers in the ViT model includes: sorting the plurality of image patch samples according to the respective importance information of the image patches to obtain a sorted result; inputting the plurality of image patch samples and the sorted result into the ViT model; determining a pruning number value for each network layer based on the pruning rate; and for input features of each network layer, pruning features corresponding to image patch samples from the input features based on the sorted result, and inputting remaining features into the network layer, in which the number of the image patch samples pruned from the input features equals to the pruning number value.

As yet another implementation, for ease of description, N is used to represent the number of network layers in the ViT model. Moreover, pruning the inputs of the network layers includes: determining a pruning number value for an i^{th} network layer based on the pruning rate, where i is an integer greater than 0 and less than or equal to N-1; determining, from the plurality of image patch samples, image patch samples to be pruned in the i^{th} network layer based on the respective importance information of the image patch samples and the pruning number value determined for i^{th} network layer; for input features of the i^{th} network layer, pruning features of image patch samples from the input features, and inputting remaining features into the i^{th} network layer, in which the number of the image patch samples pruned from the input features equals to the pruning number value; and for the input features of the N^{th} network layer, splicing and concatenating the input features with the features of all pruned image patch samples, and inputting the spliced or concatenated features into the N^{th} network layer.

Based on the above pruning processing, the result outputted by the last network layer in the ViT model is the result outputted by the ViT model.

In step 705, feature vectors of each face image sample are determined based on the result outputted by the ViT, and a face recognition result is obtained according to the feature vectors.

When the plurality of image patch samples of the face image sample are input to the ViT model, the ViT model can supplement a virtual image patch. The result obtained after the virtual image patch passes through the Transformer Encoder layer is determined as the expression of the overall information of the face image sample, such that in the result outputted by the ViT model, the corresponding feature vectors in the virtual image patch can be used as the feature vectors of the face image sample. In addition, some ViT models do not supplement a virtual image patch to learn the overall information of the face image sample. In this case, the result outputted by the ViT model can be directly used as the feature vectors of the face image sample.

Since the feature vectors of the face image sample obtained by the ViT model is equivalent to a node in the face recognition process, the feature vectors will continue to be studied by the subsequent nodes in the face recognition model, to obtain the face recognition result corresponding to the face image sample according to the feature vectors.

In step 706, the face recognition model is trained according to the face recognition result of each face image sample.

That is, corresponding loss values are calculated based on the face recognition result and the real result (or ground truth) of the face image sample, and the parameters of the face recognition model are fine-tuned according to the loss values, such that the model parameters can be applied to the corresponding pruning method.

It is noteworthy that the detailed description of the pruning processing of each network layer of the ViT model in the embodiment of the disclosure has been presented in the embodiment of the above image processing method, and will not be repeated here.

With the method for training a face recognition model according to the disclosure, the plurality of image patch samples of the face image samples are input into the ViT model, the inputs of the network layers in the ViT model are pruned based on the pruning rate of the ViT model and the respective important information of the image patch samples. The face recognition result is determined based on the feature vectors obtained by the ViT model after pruning. Thus, the ViT model can be trained according to the face recognition result. That is, the face recognition model can be trained according to the face recognition result, so that the parameters of the ViT model can be applicable to the pruning method, which can save the consumption of computing power and improve the efficiency of face recognition for the face recognition model using the ViT model.

In order to implement the above embodiments, the disclosure provides an apparatus for processing an image.

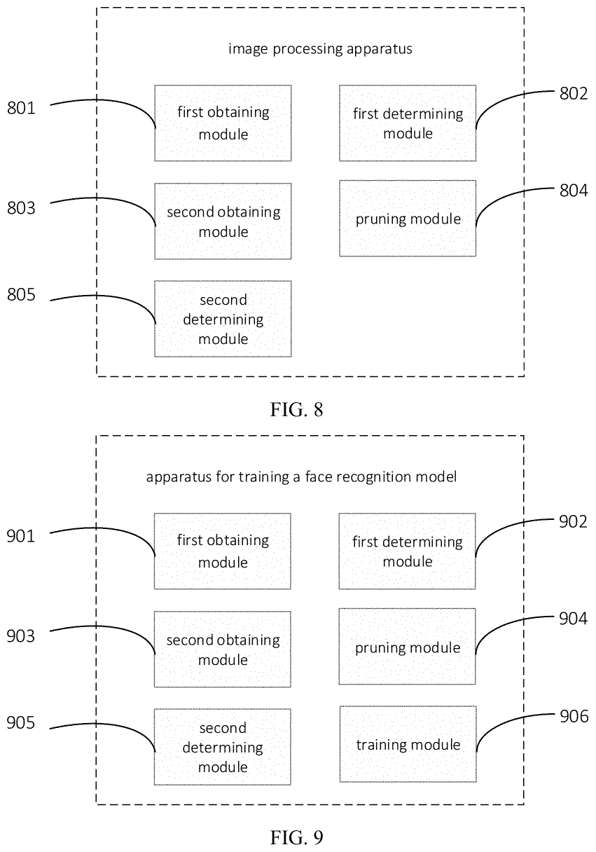

FIG. 8 is a structure diagram illustrating an apparatus for processing an image according to some examples of the disclosure. As illustrated in FIG. 8, the apparatus includes: a first obtaining module 801, a first determining module 802, a second obtaining module 803, a pruning module 804 and a second determining module 805.

The first obtaining module 801 is configured to obtain a face image to be processed, and divide the face image to be processed into a plurality of image patches.

The first determining module 802 is configured to determine respective importance information of the image patches of the face image to be processed.

The second obtaining module 803 is configured to obtain a pruning rate of a ViT model.

The pruning module 804 is configured to input the plurality of image patches into the ViT model, and prune inputs of network layers of the ViT model based on the pruning rate and the respective importance information of the image patches, to obtain a result outputted by the ViT model.

The second determining module 805 is configured to determine feature vectors of the face image to be processed based on the result outputted by the ViT model.

The first determining module 802 is further configured to: input face image samples into the ViT to obtain attention matrixes corresponding to the face image samples output by each network layer; obtain respective weights of image patch samples of each image sample by fusing all the attention matrixes; and determine the respective importance information of the image patches in the face image to be processed based on the respective weights of the image patch samples.

In some examples, the pruning module 804 is further configured to: determine a pruning number value for each network layer based on the pruning rate; in which the number of image patches to be pruned equals to the pruning number value; determine, from the plurality of image patches, image patches to be pruned in each network layer based on the respective importance information of the image patches and the pruning number value determined for each network layer; and for input features of each network layer, prune features of the image patches to be pruned from the input features, and input remaining features into the network layer.

In some examples, the pruning module 804 is further configured to: sort the plurality of image patches based on the respective importance information of the image patches to obtain a sorted result; input the plurality of image patches and the sorted result into the ViT model; determine the pruning number value for each network layer based on the pruning rate; and for input features of each network layer, prune features corresponding to image patches to be pruned from the input features based on the sorted result to obtain remaining features, and input the remaining features into the network layer, where the number of image patches to be pruned equals to the pruning number value.

In some examples, the ViT model includes N network layers, and N is an integer greater than 1, and the pruning module 804 is further configured to: determine a pruning number value for an i^{th} network layer based on the pruning rate, where i is an integer greater than 0 and less than or equal to N-1; determine from the plurality of image patches, image patches to be pruned in the i^{th} network layer based on the respective importance information of the image patches and the pruning number value determined for the i^{th} network layer; for input features of the i^{th} network layer, prune features of the image patches to be pruned from the input features, and input remaining features into the i^{th} network layer; and for input features of the N^{th} network layer, splice or concatenate the input features with the features of all image patches to be pruned, and input spliced or concatenated features into the N^{th} network layer.

With the apparatus for processing an image according to the disclosure, the plurality of image patches are input into the ViT model, and the inputs of the network layers in the ViT model are pruned based on the pruning rate and the respective importance information of the image patches. Therefore, by reducing the input features of each network layer of the ViT model, the computing power consumption of the ViT can be reduced without affecting the feature extraction of the face image, thereby improving the efficiency of image processing.

In order to realize the above embodiments, the disclosure provides an apparatus for training a face recognition model.

FIG. 9 is a structure diagram illustrating an apparatus for training a face recognition model according to some examples of the disclosure. The face recognition model includes a ViT model. As illustrated in FIG. 9, the apparatus further includes: a first obtaining module 901, a first determining module 902, a second obtaining module 903, a pruning module 904, a second determining module 905 and a training module 906.

The first obtaining module 901 is configured to obtain face image samples, and divide each face image sample into image patch samples.

The first determining module 902 is configured to determine respective importance information of the image patch samples of the face image sample.

The second obtaining module 903 is configured to obtain a pruning rate of the ViT model.

The pruning module 904 is configured to input the image patch samples into the ViT model, and prune inputs of network layers in the ViT model according to the pruning rate and the respective importance information of the image patch samples, to obtain a result outputted by the ViT model.

The second determining module 905 is configured to determine feature vectors of each face image sample according to the result outputted the ViT model, and obtain a face recognition result according to the feature vectors.

The training module 906 is configured to train the face recognition model according to the face recognition result of each face image sample.

The first determining module 902 is further configured to input the face image samples into the ViT model to obtain attention matrixes respectively corresponding to the face image samples output by each network layer; obtain respective weights of the image patch samples by combining all the attention matrixes; and determine the respective importance information of the image patch samples in each face image sample according to the respective weights of the image patch samples.

In some examples, the pruning module 904 is further configured to: determine a pruning number value for each network layer according to the pruning rate; determine, from the of image patch samples, image patches to be pruned in each network layer based on the respective importance information of the image patch samples and the pruning number value determined for each network layer; and for input features of each network layer, prune features of the image patches to be pruned from the input features, and input remaining features into the network layer.

In some examples, the pruning module 904 is further configured to: sort the image patch samples based on the respective importance information of the image patch samples to obtain a sorted result; input the image patch samples and the sorted result into the ViT model; determine the pruning number value for each network layer based on the pruning rate; and for input features of each network layer, prune features corresponding to image patch samples to be pruned from the input features based on the sorted result to obtain remaining features, and input the remaining features into the network layer, where the number of image patch samples to be pruned equals to the pruning number value.

In some embodiments of the disclosure, the ViT model includes N network layers, and N is an integer greater than 1, and the pruning module 904 is further configured to: determine a pruning number value for an i^{th} network layer according to the pruning rate, in which i is an integer greater than 0 and less than or equal to N-1; determine image patch samples to be pruned in the i^{th} network layer from the image patch samples based on the respective importance information of the image patch samples and the pruning number value determined for the i^{th} network layer; for input features of the i^{th} network layer, prune features of the image patch samples to be pruned from the input features, and input remaining features into the i^{th} network layer; and for input features of the N^{th} network layer, splice or concatenate the input features with features of all image patch samples to be pruned, and input spliced or concatenated features into the N^{th} network layer.

With the apparatus for training a face recognition model according to the disclosure, the plurality of image patch samples of the face image samples are input into the ViT model. According to the pruning rate of the model and the important information of each image patch sample, the inputs of each network layer in the ViT model are pruned, and the face recognition result is determined based on the feature vectors obtained by the ViT model after the pruning process, so that the ViT model can be trained according to the face recognition result, the face recognition model can be trained according to the face recognition result, and the parameters of the model can be applied to the pruning method, so that computing power consumption of the face recognition model using the ViT model can be saved and identification efficiency of face recognition can be improved.

According to the embodiments of the disclosure, the disclosure also provides an electronic device, a readable storage medium and a computer program product.

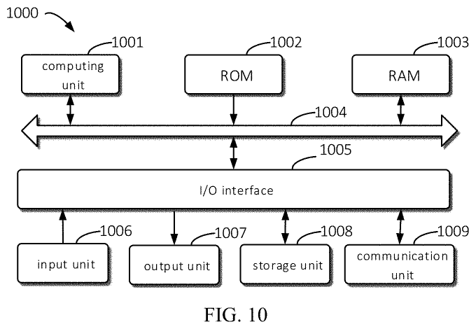

FIG. 10 is a block diagram of an example electronic device 1000 used to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 10, the device 1000 includes a computing unit 1001 performing various appropriate actions and processes based on computer programs stored in a read-only memory (ROM) 1002 or computer programs loaded from the storage unit 1008 to a random access memory (RAM) 1003. In the RAM 1003, various programs and data required for the operation of the device 1000 are stored. The computing unit 1001, the ROM 1002, and the RAM 1003 are connected to each other through a bus 1004. An input/output (I/O) interface 1005 is also connected to the bus 1004.

Components in the device 1000 are connected to the I/O interface 1005, including: an inputting unit 1006, such as a keyboard, a mouse; an outputting unit 1007, such as various types of displays, speakers; a storage unit 1008, such as a disk, an optical disk; and a communication unit 1009, such as network cards, modems, and wireless communication transceivers. The communication unit 1009 allows the device 1000 to exchange information/data with other devices through a computer network such as the Internet and/or various telecommunication networks.

The computing unit 1001 may be various general-purpose and/or dedicated processing components with processing and computing capabilities. Some examples of computing unit 1001 include, but are not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 1001 executes the various methods and processes described above, such as the image processing method, and/or, the method for training a face recognition model. For example, in some embodiments, the image processing method, and/or, the method for training a face recognition model may be implemented as a computer software program, which is tangibly contained in a machine-readable medium, such as the storage unit 1008. In some embodiments, part or all of the computer program may be loaded and/or installed on the device 1000 via the ROM 1002 and/or the communication unit 1009. When the computer program is loaded on the RAM 1003 and executed by the computing unit 1001, one or more steps of the image processing method, and/or, the method for training a face recognition model described above may be executed. Alternatively, in other embodiments, the computing unit 1001 may be configured to perform the image processing method, and/or, the method for training a face recognition model in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, a server of a distributed system, or a server combined with a block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for processing an image, comprising:
obtaining a face image to be processed, and dividing the face image to be processed into image patches;
determining respective importance information of the image patches;
obtaining a pruning rate of a preset vision transformer (ViT) model;
inputting the image patches into the ViT model, and pruning inputs of network layers of the ViT model based on the pruning rate and the respective importance information of the image patches to obtain a result outputted by the ViT model; and
determining feature vectors of the face image to be processed based on the result outputted by the ViT model.

2. The method of claim 1, wherein determining the respective importance information of the image patches comprises:
inputting the face image to be processed into the ViT model to obtain respective importance information of the image patches outputted by the ViT model, wherein the ViT model is trained by:
inputting face image samples into the ViT model, to obtain attention matrixes corresponding to the face image samples outputted by each network layer of the ViT model;
obtaining respective weights of image patch samples of each face image sample by fusing attention matrixes of the face image samples outputted by all network layers; and
determining respective importance information of the image patch samples based on respective weights of the image patch samples.

3. The method of claim 1, wherein pruning the inputs of the network layers of the ViT model according to the pruning rate and respective importance information of the image patches comprises: for each network layer,
determining a pruning number value for the network layer based on the pruning rate;
determining, from the image patches, image patches to be pruned based on the respective importance information of the image patches and the pruning number value; and
obtaining remaining features by pruning, in input features of the input of the network layer, features corresponding to the image patches to be pruned, and inputting the remaining features into the network layer.

4. The method of claim 1, wherein inputting the image patches into the ViT model, and pruning the inputs of the network layers of the ViT based on the pruning rate and the respective importance information of the image patches comprises: for each network layer,
obtaining a sorted result by sorting the image patches based on the respective importance information of the image patches;
inputting the image patches and the sorted result into the ViT model;
determining a pruning number value based on the pruning rate; and
obtaining remaining features by pruning, in input features of the input of the network layer, features corresponding to image patches to be pruned based on the sorted result, and inputting the remaining features into the network layer, wherein the number of image patches to be pruned equals to the pruning number value.

5. The method of claim 1, wherein the ViT model comprises N network layers, where N is an integer greater than 1, and pruning the inputs of the network layers of the ViT based on the pruning rate and the respective importance information of the image patches comprises:
determining a pruning number value for an i^{th} network layer based on the pruning rate, wherein i is an integer greater than 0 and less than or equal to (N-1);
determining, from the image patches, image patches to be pruned for the i^{th} network layer based on the respective importance information of the image patches and the pruning number value determined for the i^{th} network layer;
for the i^{th} network layer, pruning features corresponding to the image patches to be pruned in the input features of the i^{th} network layer to obtain remaining features, and inputting the remaining features into the i^{th} network layer; and
for the N^{th} network layer, splicing input features of the N^{th} network layer with features of all image patches to be pruned to obtain spliced features, and inputting the spliced features into the N^{th} network layer.

6. A method for training a face recognition model, wherein the face recognition model comprises a vision transformer (ViT) model, and the method comprises:
obtaining face image samples, dividing each face image sample into image patch samples;
determining respective importance information of the image patch samples of the face image samples;
obtaining a pruning rate of the ViT model;
for each face image sample, inputting the image patch samples into the ViT model, and pruning inputs of network layers of the ViT model based on the pruning rate and the respective importance information of the image patch samples, to obtain a result outputted by the ViT model;
for each face image sample, determining feature vectors of the face image sample based on the result outputted by the ViT model, and obtaining a face recognition result based on the feature vectors; and
training the face recognition model based on the face recognition result of each face image sample.

7. The method of claim 6, wherein determining respective importance information of the image patch samples comprises:
inputting the face image samples into the ViT model to obtain attention matrixes respectively corresponding to the face image samples output by each network layer of the ViT model;
obtaining respective weights of the image patch samples of each face image sample by fusing attention matrixes of the face image samples outputted by all network layers; and
determining the respective importance information of the image patch samples in each face image sample according to the respective weights of the image patch samples.

8. The method of claim 6, wherein pruning the inputs of the network layers of the ViT model according to the pruning rate and respective importance information of the image patch samples comprises: for each network layer,
determining a pruning number value for the network layer based on the pruning rate;
determining, from the image patch samples, image patch samples to be pruned based on the respective importance information of the image patch samples and the pruning number value; and
obtaining remaining features by pruning, in input features of the input of the network layer, features corresponding to the image patch samples to be pruned, and inputting the remaining features into the network layer.

9. The method of claim 6, wherein inputting the image patch samples into the ViT model, and pruning the inputs of the network layers of the ViT based on the pruning rate and the respective importance information of the image patch samples comprises: for each network layer,
obtaining a sorted result by sorting the image patch samples based on the respective importance information of the image patch samples;
inputting the image patch samples and the sorted result into the ViT model;
determining a pruning number value based on the pruning rate; and
obtaining remaining features by pruning, in input features of the input of the network layer, features corresponding to image patch samples to be pruned based on the sorted result, and inputting the remaining features into the network layer, wherein the number of image patch samples to be pruned equals to the pruning number value.

10. The method of claim 6, wherein the ViT model comprises N network layers, where N is an integer greater than 1, and pruning the inputs of the network layers of the ViT based on the pruning rate and the respective importance information of the image patch samples comprises:
determining a pruning number value for an i^{th} network layer based on the pruning rate, wherein i is an integer greater than 0 and less than or equal to (N-1);
determining, from the image patch samples, image patch samples to be pruned for the i^{th} network layer based on the respective importance information of the image patch samples and the pruning number value determined for the i^{th} network layer;
for the i^{th} network layer, pruning features corresponding to the image patch samples to be pruned in the input features of the i^{th} network layer to obtain remaining features, and inputting the remaining features into the i^{th} network layer; and
for the N^{th} network layer, splicing input features of the N^{th} network layer with features of all image patch samples to be pruned to obtain spliced features, and inputting the spliced features into the N^{th} network layer.

11. An electronic device, comprising:
at least one processor; and
a memory communicatively coupled to the at least one processor;
wherein, the memory stores instructions executable by the at least one processor, when the instructions are executed by the at least one processor, the at least one processor is configured to:
obtain a face image to be processed, and divide the face image to be processed into image patches;
determine respective importance information of the image patches;
obtain a pruning rate of a preset vision transformer (ViT) model;
input the image patches into the ViT model, and prune inputs of network layers of the ViT model based on the pruning rate and the respective importance information of the image patches to obtain a result outputted by the ViT model; and
determine feature vectors of the face image to be processed based on the result outputted by the ViT model.

12. The electronic device of claim 11, wherein the at least one processor is configured to:
inputt the face image to be processed into the ViT model to obtain respective importance information of the image patches outputted by the ViT model,
wherein the ViT model is trained by:
inputting face image samples into the ViT model, to obtain attention matrixes corresponding to the face image samples outputted by each network layer of the ViT model;
obtaining respective weights of image patch samples of each face image sample by fusing attention matrixes of the face image samples outputted by all network layers; and
determining respective importance information of the image patch samples based on respective weights of the image patch samples.

13. The electronic device of claim 11, wherein the at least one processor is configured to: for each network layer,
determine a pruning number value for the network layer based on the pruning rate;
determine, from the image patches, image patches to be pruned based on the respective importance information of the image patches and the pruning number value; and
obtain remaining features by pruning, in input features of the input of the network layer, features corresponding to the image patches to be pruned, and input the remaining features into the network layer.

14. The electronic device of claim 11, wherein the at least one processor is configured to:
obtain a sorted result by sorting the image patches based on the respective importance information of the image patches;
input the image patches and the sorted result into the ViT model;
determine a pruning number value based on the pruning rate; and
obtain remaining features by pruning, in input features of the input of the network layer, features corresponding to image patches to be pruned based on the sorted result, and input the remaining features into the network layer, wherein the number of image patches to be pruned equals to the pruning number value.

15. The electronic device of claim 11, wherein the ViT model comprises N network layers, where N is an integer greater than 1, and the at least one processor is configured to:
determine a pruning number value for an i^{th} network layer based on the pruning rate, wherein i is an integer greater than 0 and less than or equal to (N-1);
determine, from the image patches, image patches to be pruned for the i^{th} network layer based on the respective importance information of the image patches and the pruning number value determined for the i^{th} network layer;
for the i^{th} network layer, prune features corresponding to the image patches to be pruned in the input features of the i^{th} network layer to obtain remaining features, and input the remaining features into the i^{th} network layer; and
for the N^{th} network layer, splice input features of the N^{th} network layer with features of all image patches to be pruned to obtain spliced features, and input the spliced features into the N^{th} network layer.

16. An electronic device, comprising:
at least one processor; and
a memory communicatively coupled to the at least one processor;
wherein, the memory stores instructions executable by the at least one processor, when the instructions are executed by the at least one processor, the at least one processor is configured to perform the method for training a face recognition model of claim 6.
